(19) United States
(12) Patent Application Publication
(10) Pub. No.: US 2008/0275668 A1
(43) Pub. Date: Nov. 6, 2008

(54) APPARATUS AND METHOD FOR FULLY AUTOMATED CLOSED SYSTEM OPTICAL MEASUREMENT OF VOLUME

(75) Inventors: Peter Miller, New London, CT (US); Andrew Michael Leach, Clifton Park, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 11/872,880

(22) Filed: Oct. 16, 2007

Related U.S. Application Data
(63) Continuation-in-part of application No. 11/743,288, filed on May 2, 2007.

(51) Int. Cl. G06F 15/00; G01N 21/00

(52) U.S. Cl. 702/156; 356/73

(57) ABSTRACT

The present invention provides an apparatus and method for a noninvasive optical determination of the volume of a fluid in a compartment within a closed system comprising a compartment wherein a fluid resides which is permeable to at least one wavelength of light, a light source and light detecting device configured to obtain spectral data for a fluid for at least one wavelength, a processor adapted to determine the volume of the fluid by correlating the spectral data for a fluid at a known path length with the spectral data for the fluid at an unknown path length and wherein the processor is further configured to control the release of the substance from the compartment to its end use.

### REFERENCE TO RELATED APPLICATION

This application is a Continuation in Part (CIP) of U.S. patent application Ser. No. 11/743,288 entitled “APPARATUS AND METHOD FOR FULLY AUTOMATED CLOSED SYSTEM QUALITY CONTROL OF A SUBSTANCE”, filed 2 May 2007, which is herein incorporated by reference.

### BACKGROUND

This invention is directed to a method and system for determining the level of a fluid in a compartment. More specifically, it relates to a noninvasive optical measurement of a fluid in a compartment to determine its volume, where physical contact of the fluid is undesirable.

Quality Control (hereinafter “QC”) devices and methods have become an increasingly important part of industry and healthcare over the last few decades. Typically, QC devices utilize invasive methods such as testing with probes, and/or substance withdrawal techniques to assess whether the substance meets its threshold guidelines. However, invasive techniques like the ones employed in many QC apparati are not suitable for applications that require a substance to be part of an entirely closed system, or where substance loss is undesirable.

Specifically as it relates to healthcare, QC has traditionally occurred at the site of the manufacturer, as opposed to the point of use. However, with the development of new contrast agents and other unstable pharmaceutical products, it may be necessary to perform compounding or processing steps immediately prior to administration into the patient. Prior to injection, the safety and efficacy of the substance must be ensured.

In such a QC apparatus, ensuring the safety and efficacy of the pharmaceutical product being tested may occur by acquiring, for instance, the pH, temperature, concentration and/or volume of the agent while comparing those values to proper end-use values prior to administration, all without the substance leaving a closed system. In addition, a QC system that was entirely closed may operate directly at a patient's bedside, potentially obviating the need of a bedside pharmacist.

One particularly important QC parameter may be the measurement of volume. Methods and devices that have been commonly used to measure volume include volumetric containers, displacement techniques, the use of volume-flow meters in liquid-delivering apparatus, and conversion measurements based on density. While these methods may be accurate and robust, they are undesirable in situations that have limited access, require minimum material handling and transfer, require complete sterility, or have tight volume tolerance wherein material loss is to be avoided. This is especially true with respect to a pharmaceutical where improper dosing may have especially harmful implications to the patient.

The use of optics to measure physical properties of a substance is well known. For example, absorption spectroscopy has been used to measure the concentration of ions such as calcium blood and ultraviolet/visable absorption spectroscopy is often used to detect the molecular content in liquid samples. However, the use of optics to rapidly determine the volume of a fluid that is entirely part of a closed system would be desirable. Furthermore it would also be desirable to use equipment and data already present to monitor other QC parameters to determine volume, assuming that absorbance is being measured for other reasons. Other methods for determining volume require additional equipment.

Therefore, what is needed is a noninvasive, optically based method and system to determine volume in a closed system thereby obviating the need for invasive techniques involving additional material handling and transfer that may contaminate a substance or pharmaceutical product or lead to material loss.

### BRIEF DESCRIPTION

In a first aspect, the invention provides a noninvasive optical method for determining the volume of a fluid in a compartment within a closed system. The method comprises, measuring at least one optical property for a fluid in the compartment at a point wherein the path length through the fluid is known, measuring the same optical property for the fluid in the compartment at a second point wherein the path length is unknown and dependent on volume, determining the volume in the compartment based on the optical property using a correlation step, and controlling the release of the substance from the compartment to its end-use based on the volume.

In a second aspect, the invention provides a system for determining the volume of a fluid in a compartment within a closed system. The system comprises a compartment for a fluid which is permeable to at least one wavelength of light, a light source and light detecting device configured to measure at least one optical property of the fluid wherein the path length through the fluid is known, a light source and light detecting device configured to obtain optical property for the fluid wherein the path length through the fluid is unknown and dependent on volume, a processor adapted to determine volume of the fluid based on the optical data, and a release mechanism to release the fluid from the compartment to its end-use.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram of a QC device to which embodiments of the present invention are applicable.

FIG. 2 is a more detailed block diagram depicting an exemplary embodiment of a QC device, and further depicting exemplary elements of the monitoring device.

FIG. 3 is an illustration of an exemplary embodiment of a chamber having a primary region and a secondary region in fluid communication with the first.

FIG. 4 is an illustration of an exemplary embodiment of a chamber having a modified secondary region.

FIG. 5 is an exemplary example of measured volume versus absorbance for a given solution

FIG. 6 depicts an exemplary embodiment of a release mechanism comprising a physical barrier and a needle and septum, wherein the physical barrier is configured to allow the needle to pierce the compartment to release the substance if appropriate QC values are obtained.

FIG. 7 is an illustration of an exemplary MRI system and polarizing subsystem for which embodiments of the present invention are applicable.

### DETAILED DESCRIPTION

The following detailed description is exemplary and not intended to limit the invention of the application and uses of the invention. Furthermore, there is no intention to be limited by any theory presented in the preceding background of the invention or the following detailed description of the drawings.

As used herein, “adapted to,” “coupled,” “in communication” and the like refer to mechanical, structural or optical connections between elements to allow the elements to cooperate to provide a described effect.

In a first embodiment, the invention provides a noninvasive optical method for determining the volume of a fluid in a compartment. The method comprises, obtaining optical properties of the fluid for at least one wavelength wherein the path length through the fluid is known, obtaining optical properties of the fluid for at least one wavelength wherein the path length through the fluid is unknown and dependent on volume, correlating the obtained optical properties, and determining volume of the fluid in the compartment using a correlation step.

In a second embodiment, the invention provides a system for determining volume of a fluid in a compartment. The system comprises a compartment where a fluid resides which is permeable to at least one wavelength of light, a light source and light detecting device configured to measure at least one optical property of the fluid wherein the path length through the fluid is known, a light source and light detecting device configured to obtain optical property for the fluid wherein the path length through the fluid is unknown and dependent on volume, a processor adapted to determine volume of the fluid based on the optical data, and a release mechanism to release the fluid from the compartment to its end-use

In some embodiments of the invention, a mathematical model may be created to correlate the measured optical property to volume. Various methods of applying optical measurements to volume are known in the arts such as, but not limited to, absorbance, scatter and changes in refractive index. Applying the mathematical model thus created to optical property data obtained from a given fluid, it is possible to determine the volume of the fluid.

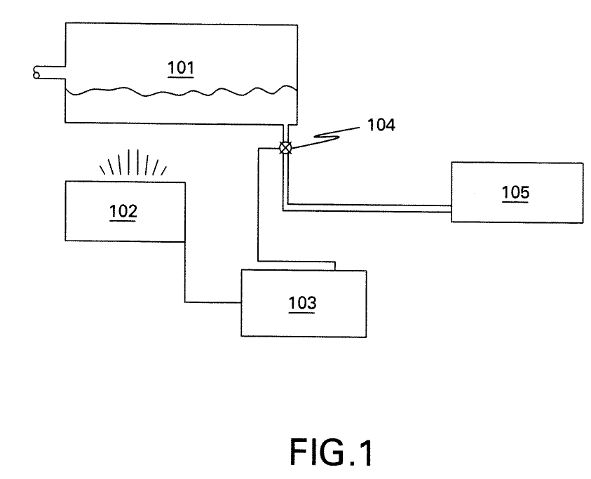

Referring to FIG. 1, there is shown a block diagram of a QC apparatus for which embodiments of the present invention are applicable. The QC apparatus comprises a compartment 101, in which a substance may be collected. As used herein, the term “fluid” comprises any liquid or gaseous solution. However, the term “fluid” may also comprise liquid crystals, colloidal dispersions, plasmas, solid suspensions, amorphous solids, or any combination thereof. For automated QC of a fluid in the compartment 101, a monitoring device 102 is coupled to the compartment 101 and is configured to gather optical, thermal, physical and/or chemical information about the fluid. The processor 103 is coupled (e.g., optically, electrically, magnetically) to the monitoring device 102, and is configured to receive data from the monitoring device 102. The processor 103 is further configured to perform a comparative analysis on the fluid in the compartment 101. A comparative analysis comprises computing applicable QC values, including but not limited to pH, fluid identity, concentration, volume, liquid-state polarization, and temperature and comparing at least one QC value against an at least one end-use acceptable value. A release mechanism 104 may function with the compartment 101 to allow for the release of the fluid, the release mechanism 104 being further coupled the processor 103. The processor 103 may be further configured to transmit a signal to a release mechanism 104, wherein the release mechanism 104 may release the fluid from the compartment 101 to its end-use 105 when a set of one or more end-use acceptable values is obtained. As used herein, “QC value,” “QC parameter” and the like refers to any property of a fluid that may be the subject of testing e.g. temperature, pH, volume, concentration, liquid-state polarization, density, identity, mass, etc. As used herein, “end-use acceptable value,” “end-use value” and the like refers to a specific value e.g. 100° C., 100 mL, any range of values e.g. 100-110° C., 100-110 mL or an upper or lower bound e.g. greater than 100° C., or less than 100 mL.

The compartment 101 may be any of any useful shape or size wherein the dimensions of the compartment are known. In an embodiment of the present invention, the compartment 101 is a rectangular in shape. The fixed path length through the fluid is the diameter of the compartment at a point where the fluid resides. The unknown path length corresponds directly to the fluid level within the compartment. However, in other embodiments the compartment may be spherical or conical in shape, or contain inflow and outflow tubes where the fluid may also be held provided dimensions are known. If the compartment is an optical block designed to cradle a receiving apparatus (not shown in FIG. 1), the shape and size of the apparatus may match the shape and size of the optical block. Furthermore, in accordance with embodiments of the present invention, the compartment 101 may be assembled with a transparent material, or may contain at least two parallel or opposing windows transparent to one or more wavelengths of light. For example, the monitoring device 102 may transmit light through one window of the compartment 101, and may detect the light transmitted through a parallel window. If, however, the compartment is made entirely of transparent material, the monitoring device 102 may transmit light through one side of the compartment 101 and detect it on a parallel side. If fluorescence is used, detection of light may occur at alternative angles (e.g., 90 or 180) of the compartment. Additionally, in more specific embodiments, the compartment 101 may be composed entirely of a low thermal mass material, such as thin glasses or plastics (e.g. Polymethyl methacrylate, polycarbonate, polystyrene, quartz, etc.) to allow for more accurate noninvasive temperature measurement. Still, in other embodiments, the compartment may be designed wherein the temperature of the compartment maybe controlled by external or internal heating and cooling elements.

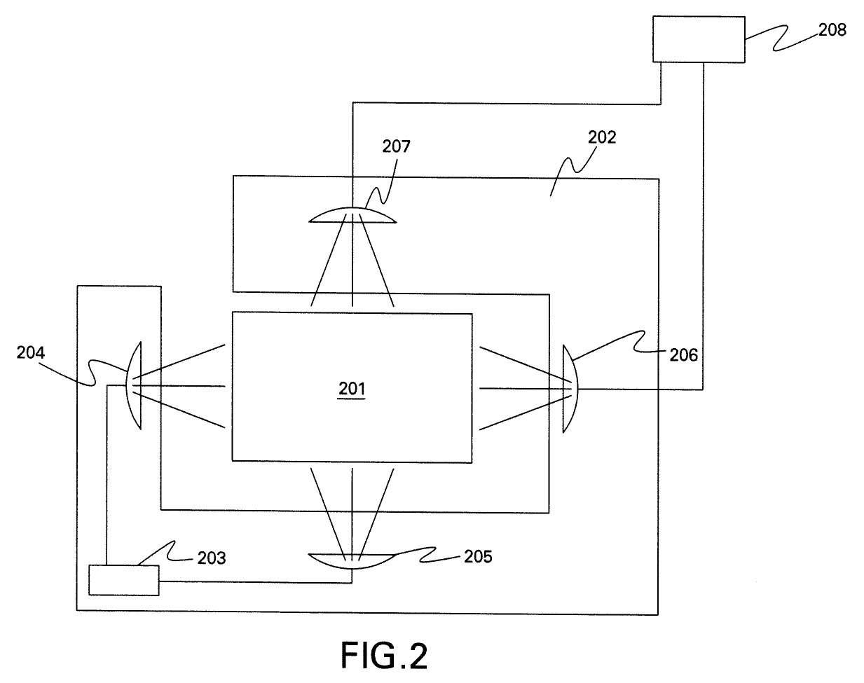

The monitoring device 102 may comprise a plurality of devices, each functioning in either a separate capacity or in conjunction with one another to measure the intrinsic properties of a fluid. With reference to FIG. 2, an embodiment of a monitoring device 202 is shown, which may be configured to gather data about the fluid in compartment 201, and may be further configured to transmit the data to the processor 208. The processor 208, using the information received from the monitoring device 202, may be configured to calculate chosen QC values. In embodiments of this particular invention, the volume of the fluid may be found. However, the processor may also calculate other QC parameters (e.g., pH, temperature, concentration, liquid-state polarization, etc.) and run a comparative analysis.

In the embodiment shown in FIG. 2, monitoring device 202 comprises one or more of a plurality of devices located within the monitoring device. In one exemplary embodiment, monitoring device 202 comprises a first light source 203 that may be fiber optics based, to allow for measurements to be taken from different dimensions of the compartment 201. For instance, light source 203 may be connected fiber optically to light transmitter 204 and 205, wherein each light transmitter may be configured to transmit light through a first and second dimension of the compartment 201. In this particular embodiment, light transmitter 204 may transmit light through the x-axis of the compartment 201 and light transmitter 205 may transmit light through the y-axis of the compartment 201. Alternatively, two separate light sources may also be used to transmit light, each positioned on different dimensions of the compartment 201 or a single light source may be used that can be repositioned about the compartment 201. The at least one light source 203 may also comprise light emitting diodes (LEDs), lasers, halogen or deuterium lamps, etc.

Referring further to FIG. 2, a first light detector 206 and a second light detector 207 may be positioned to detect the light transmitted from light transmitters 204 and 205 respectively, after the light passes through compartment 201. For example, light detector 207 may be positioned to detect light from light transmitter 205 on the y-axis, and light detector 206 may be positioned to detect light from light transmitter 204 on the x-axis of the compartment 201. Light detectors 204 and 205 are coupled, e.g. electronically, to processor 208, and communicate optical, thermal, physical, and/or chemical data gathered about the substances to the processor 208. Light detecting devices may comprise fiber optic detectors as part of a fiber optic spectrometer system, spectrophotometers, infrared emission detectors, etc.

The processor 208 may be further adapted to calculate the volume of the fluid in the compartment 201 by utilizing information gathered from the monitoring device 202. With reference to FIG. 2, the processor 208 may utilize monochromatic light or a wavelength range (herein after spectral data) to calculate volume, based on the observation that the spectral data for a given substance is concentration dependent. For example according to Beer's Law A=ε l c wherein at a given wavelength A is absorbance, ε is molar absorptivity, l is path length and c is concentration. This technique comprises producing a mathematical model correlating the volume of a fluid to the fluid's spectral data at one or more wavelengths, and loading the information into the processor 208. The processor 208 may then compare absorbance data gathered from the monitoring device and use the above referenced mathematical model to calculate the volume of the fluid based on the determination of l. For example, volume=path length×area, wherein the compartment's dimension determines area and path length is calculated from the two optical measurements.

To correlate the spectral data of the fluid with volume, the spectral data of the fluid at a known path length through the chamber is obtained, the path length being equal to the dimensions of the chamber and is constant regardless of fluid level. The spectral data of the fluid at an unknown path length through the chamber is also obtained and corresponds directly or indirectly to the fluid level. By utilizing optical relationships, commonly known to one skilled in the art, the path length of the second dimension, and therefore fluid volume, can be calculated.

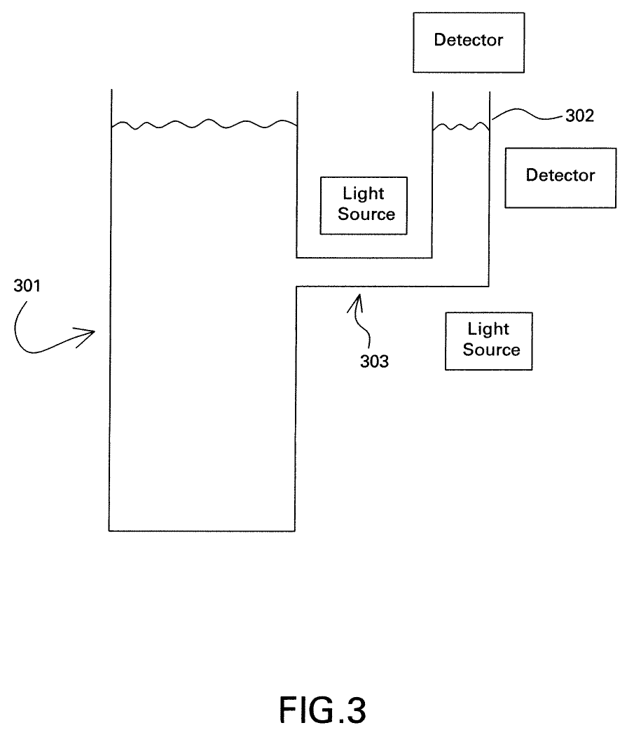

In the embodiment shown in FIG. 3 a chamber may be designed such that there is a primary region where the majority of the fluid is held and a secondary region, in fluid communication with the first, where a representative sample of the fluid resides so that the optical measurements may be made on the fluid in the secondary region. The size and position of the secondary region is dependent on the range of expected fluid volume and the optical properties of the fluid. This embodiment may be desirable where there are limitations due to the fluids optical properties. For example, if absorbance is too high or the path length is too long it may not be possible to collect the data required to solve for the unknown path length.

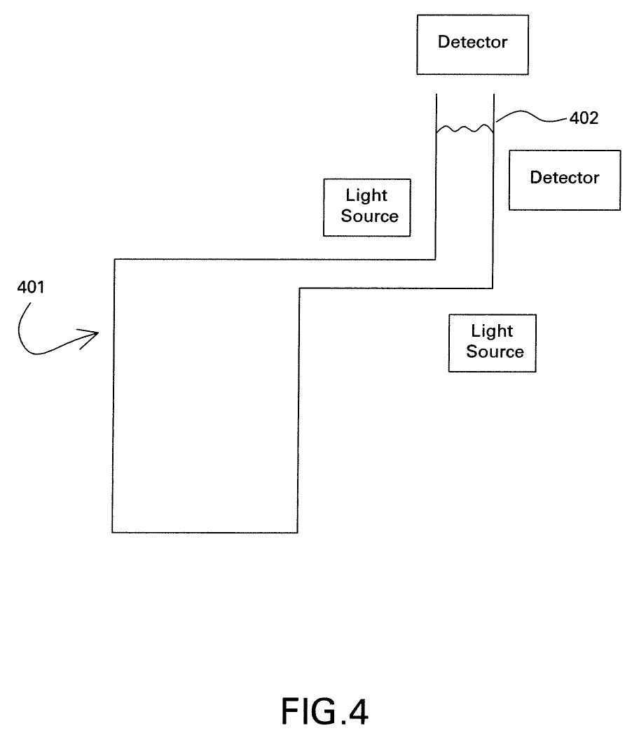

FIG. 4 illustrates that the compartment may be modified such that the dimensions of the regions are specified to improve the resolution of the volume measurement. With reference to FIG. 4 one region contains the bulk of the fluid while a second region is designed in a way that a measurable change in the unknown path length corresponds to a small variation in total volume. The dimensions of the second region are specified based on the tolerances around the volume delivery system and the resolution required by the system.

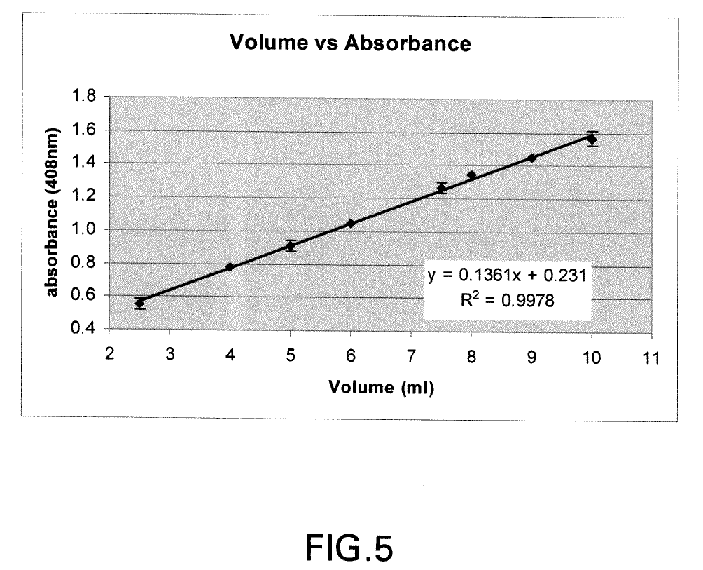

In an exemplary embodiment of the invention, the absorbance at 408 nm of an aqueous solution of 8-hydroxypyrene-1,3,6-trisulfonate (HPTS) was measured in a chamber having known dimensions and where the volume of the solution was varied from 2.5 to 10 ml. FIG. 5 shows the results of plotting the volume of the solution versus absorbance. Linear-regression statistics provides an equation in the form y=0.1361x+0.231 wherein y is absorbance, x is volume, 0.1361 is the slope of the line, and 0.231 is the y-intercept. The square of the correlation coefficient or R² is 0.9978, which is indicative of a strong linear relationship between absorbance and volume.

The mathematical model thus obtained, may make it possible to rapidly and accurately determine volume in noninvasive optical tests of the fluid, enabling the fluid to be part of an entirely closed system thereby ensuring the safety and efficacy of the fluid, and further ensuring zero substance loss.

The fluid of interest for noninvasive optical testing may be, but is not limited to, substances containing organic acids such as carboxylic acids and their corresponding salts. Common carboxylic acids are formic acid, acetic acid, propionic acid, butyric acid, valeric acid, caproic acid, enanthic acid, caprylic acid, pelargonic acid, capric acid, lauric acid, stearic acid, lactic acid, citric acid, adipic acid or pyruvic acid and any combination thereof.

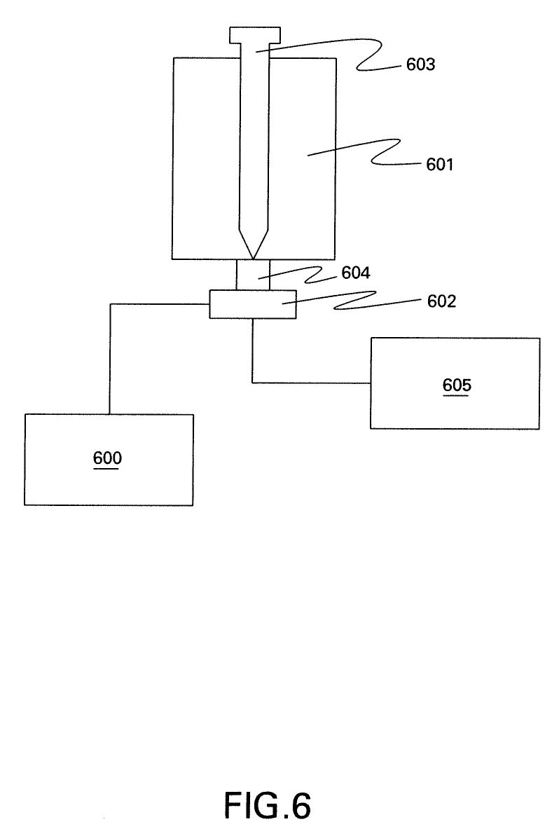

Referring to FIG. 6, an embodiment for controlling the release of a substance is shown (e.g., if the volume is appropriate). The processor 400 is coupled to release mechanism 402 which functions with the compartment 401 to release the substance to its end-use 405. The exemplary release mechanism shown in FIG. 4 comprises a needle 403 and septum 404. In this particular exemplary embodiment, the processor 400 may be configured to signal the injection of the needle 403 into the compartment 401, therein permitting the release of the substance to its end-use when one or more end-use acceptable QC values are obtained. Conversely, if the selected values for the chosen properties do not meet the chosen end-use value(s), the processor 400 will not signal the injection of the needle 403 into the compartment 401, thereby insuring that if the substance does not pass QC, it will not be released to its end-use. The operator (not shown) may have the ability to select which values, and for which properties e.g. volume, concentration, pH, etc. the processor 400 may evaluate before releasing the substance to its appropriate end-use. As used herein “operator” refers to a person, for example a clinician, who may in some embodiments of the present invention, choose QC properties and values for the QC apparatus to test. In other embodiments, the clinician merely initiates the process, and has no interactive control over the QC apparatus post-initiation. In this particular embodiment, the QC properties and values may be pre-set, for example by a regulatory committee, because it may be preferable for QC properties and values to be inaccessible to the operator thereby lessening the probability of operator error.

Generally, either the substance passes all of the appropriate QC tests and is released from the compartment 401, or it fails one or more tests and is not released. It is to be appreciated that the release mechanism 402 may also comprise a valve, a hatch, a tap, a spigot, mechanical needles or levers, restraining arms or bars, etc. Naturally, an operator may be used to initiate the process in any embodiment, e.g., by pressing a button or issuing a start command to the QC apparatus.

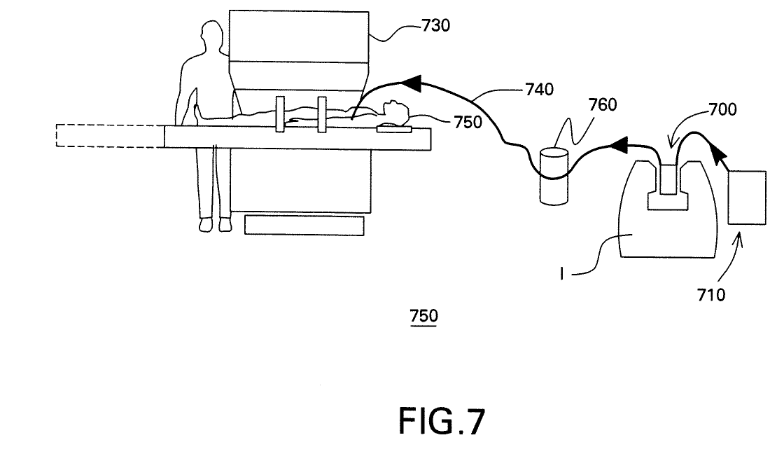

FIG. 7 is an illustration of an exemplary MRI system and polarizing subsystem for which embodiments of the present invention may also be applicable.

Referring to FIG. 7, a exemplary system 550 is shown for producing hyperpolarized samples for use in a MRI device and includes a cryostat 1 and polarizing subsystem 500 for processing material from compartment 510 and resulting in the hyperpolarized material. A material delivery line 540 is used to deliver the hyperpolarized material to subject 550 within MRI scanner 530. In the embodiment shown in FIG. 7, the hyperpolarized samples are used in an in vivo imaging application, where the hyperpolarized samples must undergo automated QC analysis to ensure that proper efficacy and safety standards are met before the product is released for patient delivery through line 540

Referring further to FIG. 7, compartment 510 contains a solid sample of the sample to be polarized can be polarized while still in the solid phase by any appropriate known method, e.g. brute force polarization, dynamic nuclear polarization or the spin refrigerator method, while being maintained at a low temperature (e.g. under 100 K) in a strong magnetic field (e.g. 1-45 T). After the solid sample has been polarized, it is melted with a minimum loss of polarization. In the following the expression “melting means” will be considered to mean the following: a device capable of providing sufficient energy to the solid polarized sample to melt it or otherwise bring the polarized sample into solution for introduction into the subject being imaged. As used herein, the term “solid” refers to solid materials; semi-solid materials or any combination thereof provided the material requires some transformation to attain a liquid state suitable for introduction into a subject being imaged.

When the polarized material is in its liquid state, held in polarized sub-system 500, embodiments of the present invention are applicable. In this exemplary embodiment, ¹³C pyruvate in polarized form is the substance to be used during in vivo imaging, and is therefore also the substance subject to QC analysis, which may take place in receiving compartment 560 of the polarized subsystem. One particular aspect of QC analysis is accurately determining the volume of the pyruvate solution using the method and system of the present invention.

Although the preceding example is a medicinal use, industrial uses, such as assembly lines and food processing, pharmacological uses, any instance where material loss is an issue, etc.

While only certain features of the invention have been illustrated and described herein, many modifications and changes will occur to those skilled in the art. It is, therefore, to be understood that the appended claims are intended to cover all such modifications and changes as fall within the true spirit of the invention.

We claim:

1. A noninvasive optical method for determining the volume of a fluid in a compartment within a closed system comprising:
placing a fluid in a compartment wherein the compartment is permeable to at least one wavelength of light;
measuring at least one optical property of the fluid in the compartment at a point wherein the path length through the fluid is known;
measuring at least one optical property of the fluid in the compartment at a second point wherein the path length through the fluid is unknown and dependent on the amount of fluid in the compartment;
determining the fluid volume in the compartment using optical properties; and
controlling the release of the fluid from the compartment to its end-use if the fluid volume is within a predetermined range.

2. The method of claim 1 wherein the optical property comprises absorbance, absorption, transmission, scattering effect, refractive index, and any combination thereof.

3. The method of claim 1 wherein the known path length through the fluid is the diameter of the compartment.

4. The method of claim 1 wherein the compartment comprises:
a first chamber for holding a fixed volume of the fluid; and
a second chamber in fluid communication with the first for holding a variable volume of the fluid and wherein optical properties are measured on the second chamber.

5. The method of claim 4 wherein the dimensions of the second chamber is specified to improve the resolution of the measurement of optical property wherein a measurable change in optical properties corresponds to a small change in total volume.

6. The method of claim 1 further comprising monitoring or controlling the temperature of the closed system.

7. The method of claim 1, wherein the method is functionally adapted for integration into a sterile system, wherein the method operates to determine the volume of a fluid and further ensure the sterility of a fluid in the sterile system.

8. The method of claim 7, wherein the determination of volume further comprises an initiation step preformed by an operator and wherein subsequent steps are fully automated.

9. A non-invasive system for determining the volume of a fluid in a compartment within a closed system comprising:
a compartment capable of holding a fluid which is permeable to at least one wavelength of light;
a light source and light detecting device configured to obtain optical data for the fluid;
a processor adapted to determine the volume of the solution by correlating the optical data obtained; and
a release mechanism to release the substance to its end-use.

10. A system of claim 9 wherein the light source and light-detecting device are not fixed and can be positioned about the compartment.

11. A system of claim 9 further comprising a second light source and second light-detecting device.

12. A system of claim 9 wherein the light source is a fiber optic based spectrometer.

13. The system of claim 9, wherein the processor is further adapted to employ a mathematical model wherein the model comprises determining a statistical relationship between a fluid's optical property and volume.

14. The system of claim 9 further comprising a temperature controller.

15. The system of claim 9, wherein the system is functionally adapted for integration into a sterile substance path, wherein the system operates to determine volume and further to ensure sterility of a substance in the sterile substance path.

16. The system of claim 9, wherein the processor further functions to allow an initiation step to be preformed by an operator and wherein subsequent steps are fully automated.

17. The system of claim 9, wherein the release mechanism operates to release the fluid from the compartment to its end use if the volume is within a predetermined range.
